(19) United States
(12) Patent Application Publication
(10) Pub. No.: US 2009/0017426 A1
(43) Pub. Date: Jan. 15, 2009

(54) SYSTEMS AND METHODS FOR PLAYING EDUCATIONAL GAMES AND USING EDUCATIONAL TOOLS

(75) Inventor: William Y. Higgins, Kenmore, WA (US)

Correspondence Address: PERKINS COIE LLP;PATENT-SEA, P.O. BOX 1247, SEATTLE, WA, 98111-1247, US

(73) Assignee: MindWare Inc., Kenmore, WA (US)

(21) Appl. No.: 12/172,096

(22) Filed: Jul. 11, 2008

Related U.S. Application Data
(60) Provisional application No. 60/959,376, filed on Jul. 13, 2007.

(51) Int. Cl. G09B 19/22

(52) U.S. Cl. 434/128; 273/236

(57) ABSTRACT

Systems and methods for playing games and using other educational tools are disclosed herein. In some embodiments, entertaining and educational game systems are provided for increasing players' global awareness. In other embodiments, players can experience life challenges faced by denizens of emerging markets and/or countries. In one embodiment, a game system for playing games includes a playing surface having an image of a representative geographical location and a plurality of spaced-apart player movement spaces for positioning player tokens. The system further includes a plurality of vocation indicia for communicating vocation based information. The vocation based information can include a vocation description (e.g., describing a possible vocation of a denizen of the representative geographical location) assumable by a player. The system can also include a plurality of instructional play indicia for communicating a possible life experience that the denizen may experience.

### CROSS-REFERENCE TO APPLICATION(S) INCORPORATED BY REFERENCE

The present application claims priority to U.S. Provisional Patent Application No. 60/959,376, filed Jul. 13, 2007, entitled “SYSTEMS AND METHODS FOR PLAYING CULTURE GAMES AND USING EDUCATIONAL TOOLS,” and incorporated herein in its entirety by reference.

### COPYRIGHT NOTICE

Portions of the disclosure of this patent document contain material that is subject to copyright protection. The copyright owner has no objection to the facsimile reproduction by anyone of the patent document or patent disclosure as it appears in the Patent and Trademark Office patent file or records, but otherwise reserves all rights to copyright protection.

### TECHNICAL FIELD

The present disclosure is directed generally to educational games and learning tools for simulating living and working in an emerging market or less developed country.

### BACKGROUND

Educational and entertainment travel and trivia games currently exist. In some travel oriented games, participants can travel to foreign countries/places and/or visit tourist sites. Conventional educational games can include themed topics or a variety of topics for testing a participant's knowledge. For example, the participant can be tested on geography, history, pop culture, etc. Other games are designed to simulate business ventures wherein participants design, buy and start businesses or advance along simulated corporate career paths. Games can be provided in physical form, such as board games, or as computer-implemented games wherein the participants can initiate and play games using a computing device. Typical games, including educational and entertainment games are competitive in nature and are designed to have a single winner or team via accumulation of points, forward movement, task completion, etc.

### BRIEF DESCRIPTION OF THE DRAWINGS

FIG. 1 is a perspective view of a game system in accordance with an embodiment of the disclosure;

FIG. 2 is a perspective view of a game system illustrating additional game components in accordance with an embodiment of the disclosure;

FIG. 3A is a top perspective view of a game board in accordance with an embodiment of the disclosure;

FIG. 3B is an enlarged perspective view of the game board of FIG. 3A, illustrating a plurality of player tokens resting on player movement spaces;

FIG. 4 is a plan view of a plurality of vocation cards in accordance with an embodiment of the disclosure;

FIG. 5 is a plan view of a plurality of opportunity cards in accordance with an embodiment of the disclosure;

FIG. 6 is a plan view of a plurality of life situation cards in accordance with an embodiment of the disclosure;

FIG. 7 is a plan view of country-specific paper currency illustrating a plurality of denominations in accordance with an embodiment of the disclosure;

FIG. 8 is a plan view of a translation guide in accordance with an embodiment of the disclosure;

FIG. 9 is a plan view of a plurality of vocation-specific scoring sheets in accordance with an embodiment of the disclosure;

FIG. 10 is a flow diagram illustrating a method for playing a culture game using a game system in accordance with an embodiment of the disclosure;

FIG. 11 is a top perspective view of a game board in accordance with an embodiment of the disclosure;

FIG. 12 is a top perspective view of a game board in accordance with another embodiment of the disclosure

FIG. 13 is a top perspective view of a game board in accordance with a further embodiment of the disclosure;

FIG. 14 is a flow diagram illustrating a method for developing and implementing a game that simulates living in a representative geographical location; and

FIG. 15 is a block diagram of a basic and suitable computer that may employ aspects of the disclosure.

### DETAILED DESCRIPTION

Various embodiments of the present disclosure are directed to systems and methods for culture-based games and educational tools. As described in greater detail below, in at least one embodiment of the present disclosure, an entertaining and educational game system is provided for increasing a player's global awareness. In one embodiment, a player can experience the life challenges faced by denizens of emerging markets and/or countries. For example, the game system can simulate living and working in a country with an emerging market, or other country, to provide educational opportunities for players. In some embodiments, the game system can include a playing surface (e.g. a game board, game table, etc.), playing cards with information and/or instructions, identifiable player tokens, and a random number generator. The game system can also include country-specific currency in one or more denominations, a scoring card, and a translation guide.

In various embodiments, a plurality of players can choose tokens, be randomly assigned vocations, and play the game according to a pre-determined set of rules (described in more detail below). In some embodiments, players can play the game on a physical playing surface and use physical game components. In other embodiments, the game can be implemented on a networked or non-networked computer system for single player games, multi-player games, and games with remote players.

A game system for playing games in accordance with an aspect of the disclosure includes a playing surface having an image for representing a geographical location. The system also includes a plurality of spaced-apart player movement spaces for positioning one or more player tokens on the playing surface. The player movement spaces can be arranged in one or more paths on the playing surface. The system further includes a plurality of vocation indicia for communicating vocation based information. The vocation based information can include a vocation and a vocation description assumable by a player. In some embodiments, the vocation description can describe a possible vocation of a denizen of the representative geographical location. The system can also include a plurality of instructional play indicia for communicating one or more play events, wherein the one or more play events can include a description of a possible life experience that a denizen of the geographical location may experience.

In accordance with another aspect of the disclosure, a game system for playing games that simulate living in a representative country can include a game board having a playing surface. The playing surface can include an image of the representative country and a player movement path. The player movement path can have spaced-apart player position spaces, the player position spaces providing designated spaces on the playing surface in which player tokens may stop during play. One or more player position spaces can include player instructions for taking an action. The system also includes a plurality of vocation cards for communicating vocation based information. The vocation based information can include a vocation and a vocation description assumable by a player, wherein the vocation description describes a possible vocation of a denizen of the representative country.

In additional embodiments, the system can also include a plurality of opportunity cards for communicating one or more opportunities to a player, wherein the opportunities include one or more possible opportunities available to the denizen of the representative country. In a further embodiment, the system can include a plurality of situation cards for communicating one or more life experiences to a player. The life experiences can include one or more possible life situations experienced by the denizen of the representative country. The system also includes country-specific currency, the currency having one or more denominations. In one embodiment, each player receives currency based on an income-level. The system further includes a plurality of player tokens for associating with a player.

Another aspect of the disclosure is directed toward a method for developing and implementing a game that simulates living in a representative geographical location. The method can include providing a playing surface. The playing surface can include an image of the representative geographical location and a player movement path. The player movement path can include a plurality of spaced-apart player position spaces. The method can also include providing information relating to living in the representative geographical location. In various embodiments, the information can include one or more of (a) possible vocations available to denizens of the representative geographical location, (b) possible opportunities available to the denizens, (c) possible life situations encountered by the denizens, and (d) one or more current events relevant to the denizens. The method can further include providing indicia for communicating the information to players. In accordance with some embodiments of the disclosure, the method can include providing currency for simulating disbursement of an income and/or collection of a payment for living expenses from a player during game play.

The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

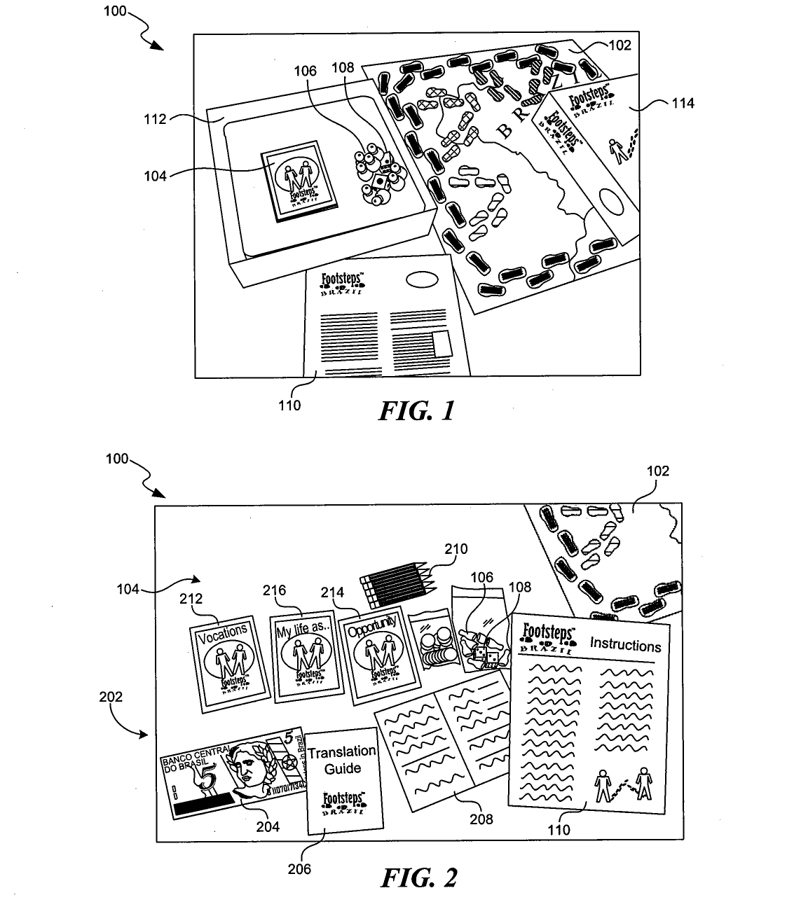

FIG. 1 is a perspective view of a game system 100 in accordance with an embodiment of the present disclosure. The game system 100 can include a game board 102 (or other playing surface), playing cards 104 (e.g., playing indicia), identifiable player tokens 106, a set of die 108 (or other random number generator), and a set of instructions and/or game rules 110. The game system 100 can also include a carrying box 112 having marketing and/or playing information on an outer surface 114.

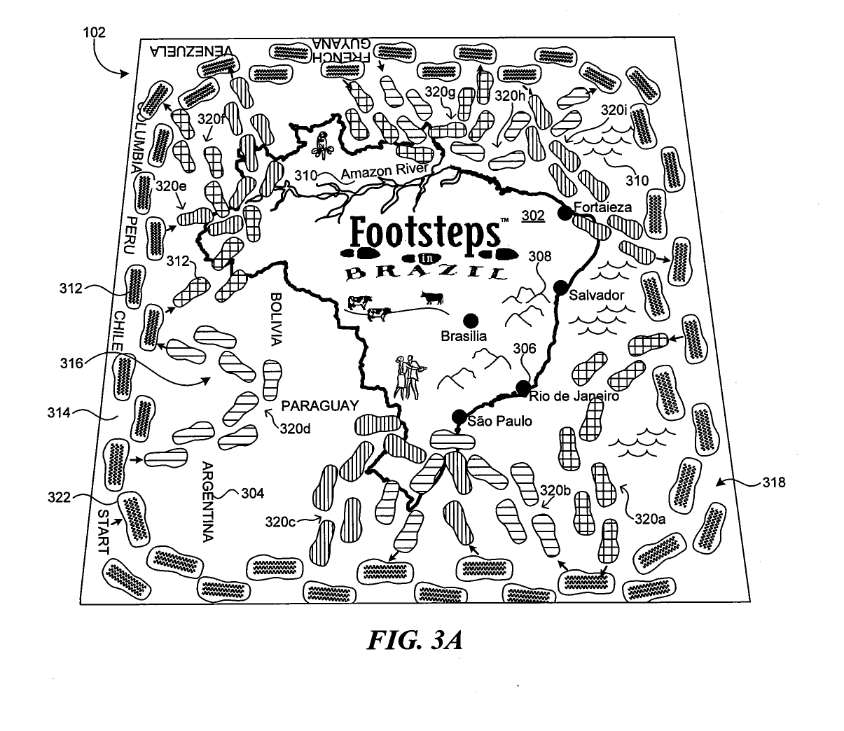

FIG. 2 is perspective view of the game system 100 of FIG. 1 illustrating additional game components 202 in accordance with an embodiment of the disclosure. Additional game components can include for example, country-specific paper currency 204, a mini-translation guide 206, scoring sheets 208, writing utensils 210, etc. Furthermore, and as described in more detail below, the playing cards 104 may be of one or more types of playing card 104. In one embodiment, the playing cards 104, and/or other indicia, can include “Vocation” cards 212, or other types of cards to signify the vocation of the player. In another embodiment, the playing cards 104 can include “Opportunity” cards 214, or other types of cards to signify opportunities that a player can choose to take or experience. In further embodiments, the playing cards 104 can include “situation” cards 216 (e.g. “My Life As . . . ” cards), or other types of cards communicating life events that a player can experience during game play. Those of ordinary skill in the art will recognize other playing cards 104 and other game components 202, as well as additional game component styles and designs in accordance with features of the disclosure.

Referring to FIGS. 1 and 2, the instructions and/or game rules 110 can provide an overview of the game, play objective, explanation of game components 102, 104, 106, 108, 202, etc. The instructions 110 can also provide direction for how to set up the game, step-by-step playing instructions and rules, describe how to win the game, strategy tips, etc. One of ordinary skill in the art will recognize additional game playing directions and rules that can be included in the instruction set 110.

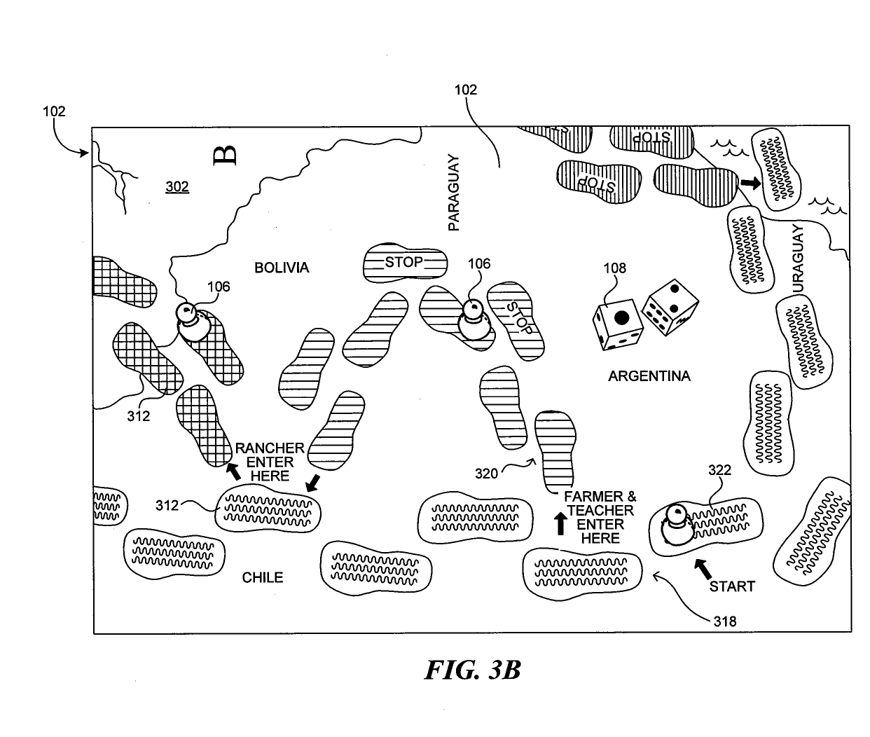

FIG. 3A is a top perspective view of a game board 102 in accordance with one embodiment of the disclosure. As shown, the game board 102 includes a country map 302 with surrounding countries 304. The map can also include reference markings for major cities 306, geological landmarks such as mountains 308 and bodies of water 310, etc. In other embodiments, the playing surface and/or game board 102 includes an image representing a geographical location. For example, the image can be an outline shape depicting a homestead, a city, a county, a country, a continent, etc. In other embodiments, the image may not depict the representative geographical region. For example, the image, while representing the geographical region, can appear abstract in shape.

The game board 102 can also include a plurality of spaced-apart player movement spaces 312. For example, player movement spaces 312 can be spaced-apart position spaces in which players may stop and/or place player tokens during play. Player movement spaces 312 can be placed around a perimeter 314 of the game board 102 or in an interior 316 of the game board 102. In one embodiment, the player movement spaces 312 are permanently superimposed over the country map 302 and surrounding countries and geological landmarks 308, 310. In another embodiment, the player movement spaces 312 can be moveable relative to the game board 102. In one embodiment, the player movement spaces 312 are shaped like footsteps. In other embodiments, the player movement spaces 312 can have additional or a variety of shapes, such as circles, squares, triangles, people, stepping stones, railroad tracks, etc. As illustrated in FIG. 3A, the player movement spaces 312 can be direction-oriented such that a player can play progressively in a single direction. In other embodiments, player movement spaces 312 can be multi-directional allowing for forward or backward movement during play.

In the illustrated embodiment, the game board 102 includes a map of Brazil 302 and a plurality of player movement spaces 312 around the perimeter 314 of the game board 102 to form a primary player path 318 along which a player can move his or her player token during game play. The game board 102 can also include additional player movement spaces 312 in the interior 316 of the game board 102 to form a plurality of side paths 320 (independently designated 320a-320i). In the embodiment shown in FIG. 3A, six side paths 320a-320i are illustrated; however, the game board 102 can include less or more side paths 320 in additional embodiments. Furthermore, the player movement spaces 312 can contain country-specific information and/or playing instructions, or the player movement spaces 312 can be blank. For example, an individual player movement space can contain information for players to respond to or instructions indicating a play card 104 to be drawn. One of ordinary skill in the art will recognize additional game board designs having country maps 302 of different countries and/or geographical regions. Additionally, those of ordinary skill in the art will appreciate that the player movement spaces 312 can take other forms and be placed in different locations on the game board 102 with respect to the location of the country map 302 and surrounding countries 304. In some embodiments, a designated start space 322 can be indicated as a start point for beginning a new game.

FIG. 3B illustrates a plurality of player tokens 106 resting on the game board 102 and aligned with player movement spaces 312. Player tokens 106 can have any shape, color, texture, etc. that provides a uniquely identifying feature. The player tokens 106 can also be sized larger or smaller depending on the size of the game board 102, the age of the player, or other factors. Also shown is a set of die 108. The set of die 108 can be used, in one embodiment, to randomly generate numbers for advancing player tokens 106 on the paths 318, 320. Other random number generating devices (e.g. a spin dial, an electronic number generator, etc.) can also be used during game play.

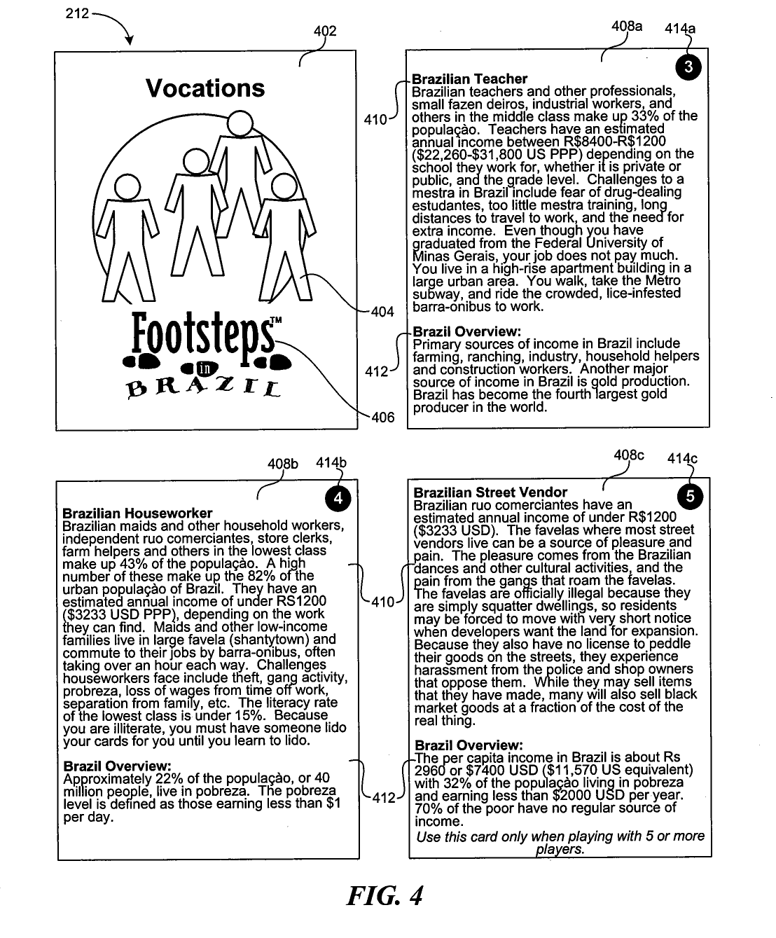

FIG. 4 illustrates a plurality of vocation cards 212 in accordance with an embodiment of the disclosure. Vocation cards 212 can have a front side 402 with artwork 404, card information 406, etc. Vocation cards 212 can also have a back side 408 (examples of which are shown at 408a-408c) opposite the front side 402. A plurality of back sides 408a-c are illustrated in FIG. 4 and each back side 408 shows vocation based information 410, such as vocation type (e.g., houseworker, teacher, farmer, etc.) income level (e.g., high-, middle-, low-income, etc.), work-related challenges (e.g., equipment failure, employee disagreements, etc.), worker literacy level, and other vocational information and/or overview information 412 specific to the country game system 100. It is understood that the vocation based information 410 shown on the back sides 408a-c are only illustrative and that the vocation cards 212 can include different and/or other job, work and/or profession-related information suitable for including or using with the game system 100.

In one embodiment, the game system 100 includes eight vocation cards 212. In other embodiments, the game system 100 can include more or less than eight cards 212. In some embodiments, the back side 408 of the vocation cards 212 can include a numerical or other identifier 414 instructing players to use the card 212 when the number of players is equal to or greater than number indicated by the identifier 414. For example, the vocation card 212 including the back side 408c having identifier 414c (e.g., the number “5”), can be used with the game system 100 when at least 5 players are engaged in a game session. In some embodiments, vocation cards 212 can communicate vocation based information 410 via textual characters, and in other embodiments, the vocation based information 410 can be communicated via illustrations and/or images.

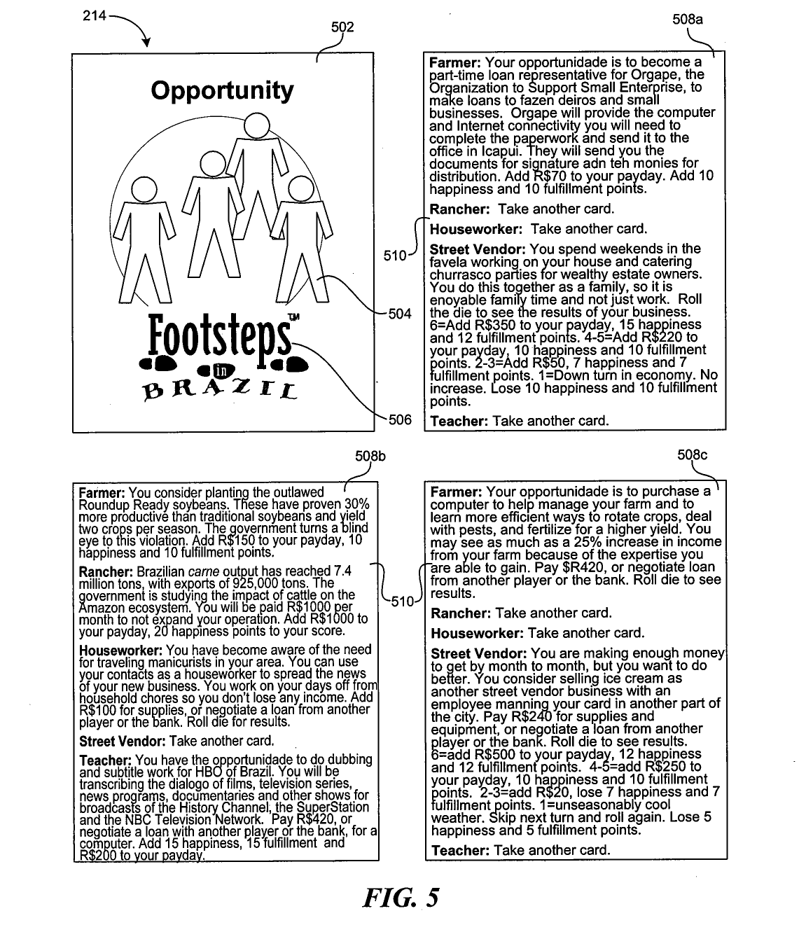

The game system 100 can also include a plurality of opportunity cards 214, as shown in FIG. 5. Opportunity cards 214 can have a front side 502 with artwork 504, card information 506, etc. Opportunity cards 214 can also have a back side 508 (examples of which are shown at 508a-508c) opposite the front side 502. On the back side 508, opportunity cards 214 can contain opportunity information 510 describing a variety of opportunities that are presented to the players during play. In one embodiment, the opportunities are vocation-specific. In other embodiments, the opportunity information 510 is income-level specific. For example, the opportunity information 510 can include descriptions of specific situational opportunities appropriate for each income level and ones that denizens of the representative country may expect to experience. Opportunities, for example, can include investments, entrepreneurial endeavors, technology upgrades to a player's business, etc.

The opportunity information 510 presented on each opportunity card 214 can indicate the financial investment required to take advantage of the presented opportunity, the income a player could expect to obtain with a successful venture, several possible returns based on the use of the random number generator (e.g. a roll of the dice 108) to simulate the risk factors regarding success or failure of the opportunity, etc. In some embodiments, success or failure of the opportunity can be represented by financial gain or loss of currency held by a player, or by addition or subtraction of wealth points. In other embodiments, success or failure of the opportunity can be represented by addition or subtraction of other points, such as happiness points and/or fulfillment points. Point tallies can be kept on a scoring sheet 208 or other tally system.

In some embodiments of the game system 100, the number of opportunity cards 214 can be twelve. In other embodiments, the number of opportunity cards 214 can be less than or greater than twelve cards 214.

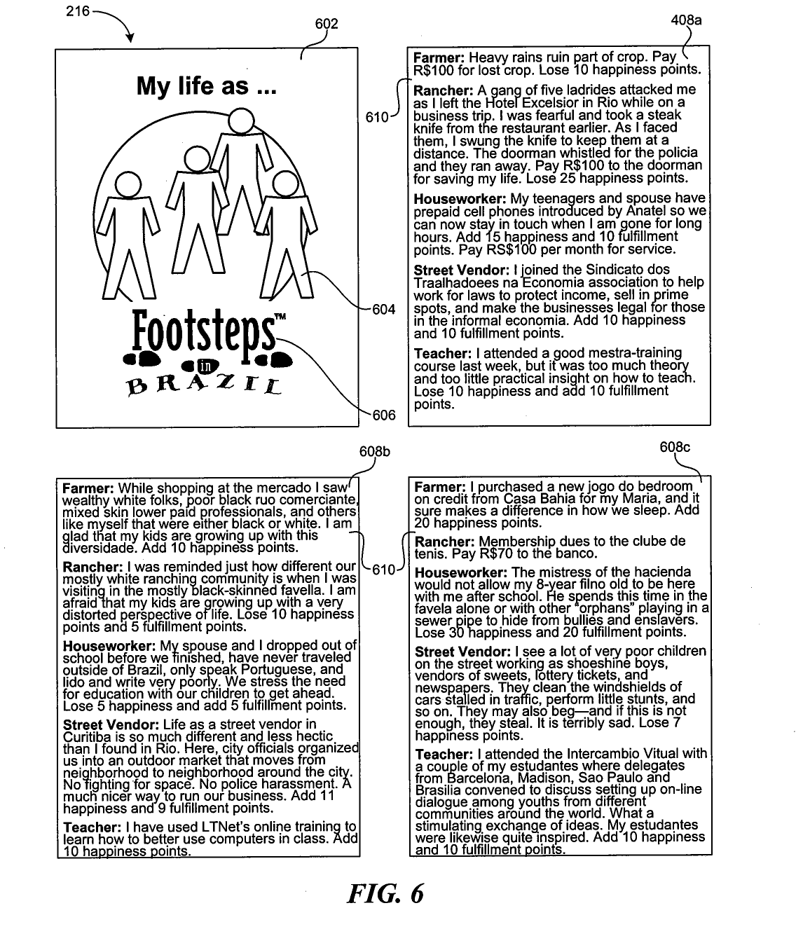

FIG. 6 illustrates a plurality of situation cards 216 (e.g. “My Life As . . . ” cards) in accordance with an embodiment of the disclosure. Situation cards 216 can have a front side 602 with artwork 604, card information 606, etc. Situation cards 216 can also have a back side 608 (examples of which are shown at 608a-608c) opposite the front side 602. On the back side 608, situation cards 216 can contain situation information 610 describing a variety of specific life experiences appropriate for each income level and ones that denizens of the representative country may expect to experience. For example, a life experience described by the situation information 610 can be the marriage of a child, a birth or a death in the family, an education opportunity, an illness, etc.). The situation information 610 can include the circumstances of the situation, the consequences derived from the situation, and changes in happiness level, fulfillment, wealth, etc., that the players incur as a result of playing that card.

In some embodiments, situation information 610 can describe a positive or negative event or circumstance that the player encounters during game play. Positive and Negative events can be represented by addition or subtraction of wealth points, happiness points and/or fulfillment points. Point tallies can be kept on a scoring sheet 208 or other tally system. The game system 100, in one embodiment, can have twenty situation cards 216. In other embodiments, however, the number of situation cards 216 can be more or less than twenty.

One of ordinary skill in the art will appreciate that vocation cards 212, opportunity cards 214, situation cards 216, and other playing cards 104 can include additional information and instructions. Moreover, the playing cards 104 can be formed from paper, cardboard, plastic, or other planar material. In other embodiments, the playing cards 104 can be in a virtual format and stored on computer readable material or other electronic readable material, such as a CD or audio tape. Artwork 404, 504, 604 and/or textual information 406, 410, 412, 506, 510, 606, 610 can be printed, embossed or applied to the playing cards 104 with techniques and materials known in the art such that the information can be communicated to the players. In other embodiments, the information 406, 410, 412, 506, 510, 606, 610 can be audibly recorded, digitally recorded, or electronically recorded by other means for storing and retrieving information 406, 410, 412, 506, 510, 606, 610 using a computer and/or other audio-based devices.

In one embodiment, the information 406, 410, 412, 506, 510, 606, 610 can be communicated in a single language such that a player using the game system 100 can read the information 406, 410, 412, 506, 510, 606, 610 in his or her preferred language (e.g., English, Spanish, Italian, French, etc.). In another embodiment, the information 406, 410, 412, 506, 510, 606, 610 can be communicated in the language (e.g., Portuguese, Russian, etc.) commonly used in the representative country or geographical location featured in the game system 100. In a further embodiment, and as shown in FIGS. 4-6, the information 406, 410, 412, 506, 510, 606, 610 can be communicated in a combination of languages (e.g., English and Portuguese, English and Russian, etc.).

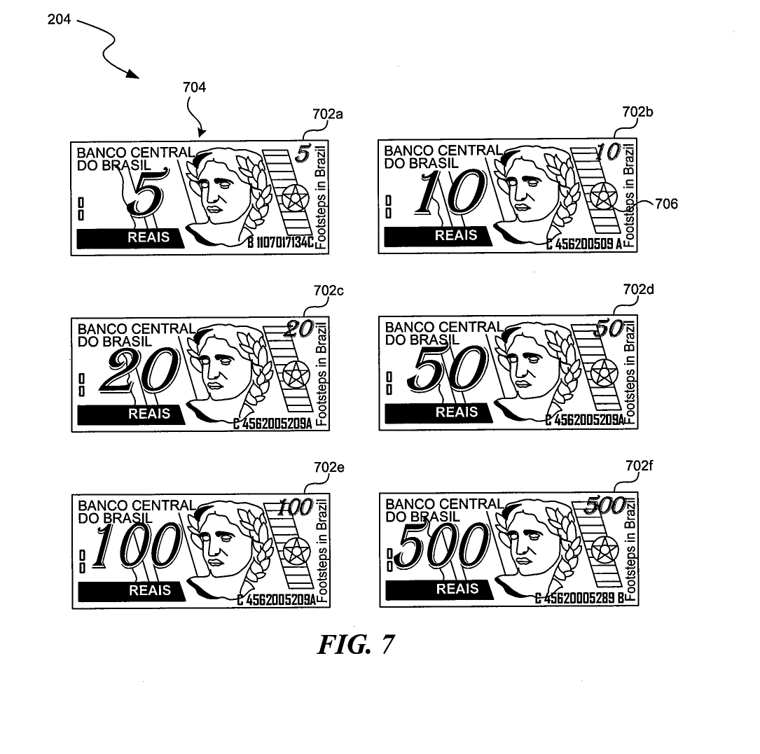

In accordance with the embodiment of the disclosure shown in FIG. 2, the game system 100 can also include country-specific paper currency 204. As illustrated in FIG. 7, the country-specific paper currency 204 can comprise paper currency 204 in a plurality of denominations 702 (shown individually at 702a-702f). The denominations 702 can appear to be authentic currency 204 of the country represented in the game system 100, including color, language, indicia, design, size, etc. An example of the Brazilian-specific paper currency 204 is illustrated in FIG. 7. The real (note) is the currency of Brazil (plural Reais) shown in denominations of R$ 5 (702a), R$ 10 (702b), R$ 20 (702c), R$ 50 (702d), R$ 100 (702e), R$ 500 (702f), and includes an authentic design 704, indicia 706, etc. As is known in the art, the paper currency 204 can be formed of paper, cardboard, plastic, or other substantially planar material. The denominations, designs, indicia, colors, etc. can be printed, embossed, or applied to the currency with techniques and material known in the art. One of ordinary skill in the art will recognize that authentic appearing currency is not a requirement of the game system 100 and that additional value-containing components, or representatives thereof, can be used in the game system including coin currency, notes of other denominations, titles of land ownership, heads of cattle, etc.

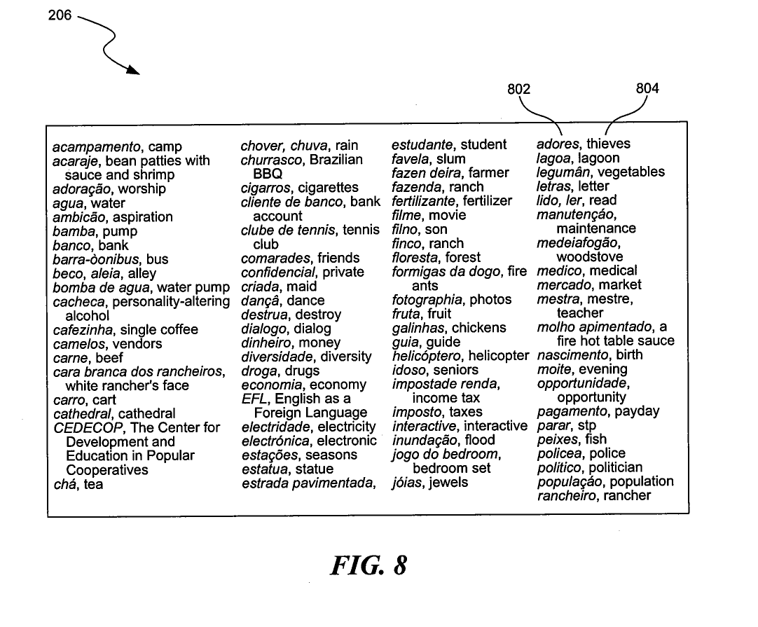

The game system 100 can also include a mini-translation guide 206, as shown in FIG. 8. In the illustrated embodiment, the mini-translation guide 206 can provide the translation of terms 802 in one or more languages commonly used in the representative country or geographical location featured in the game system 100 with an equivalent term 804 in a native or spoken language of the players. For example, if the game system 100 is directed to playing in the country of Brazil and sold in the United States, the terms 802 can be in Portuguese and the equivalent terms 804 can be in English. In other embodiments, the terms 802 in the language of the representative country can be translated into terms 804 of additional or other languages. The mini-translation guide 206 can include terms 802, 804 that are used in the everyday conversations of denizens of the representative country, can encompass additional terms 802, 804 useful to experiences and opportunities that the players will encounter during play, etc. Other embodiments can include additional terms 802, 804. The mini-translation guide 206 can be printed, embossed, or otherwise applied to paper, cardboard, plastic, etc. In further embodiments, the mini-translation guide 206 can be audibly recorded, digitally recorded, or electronically recorded by other means for storing and retrieving terms 802, 804 using a computer and/or other audio-based devices.

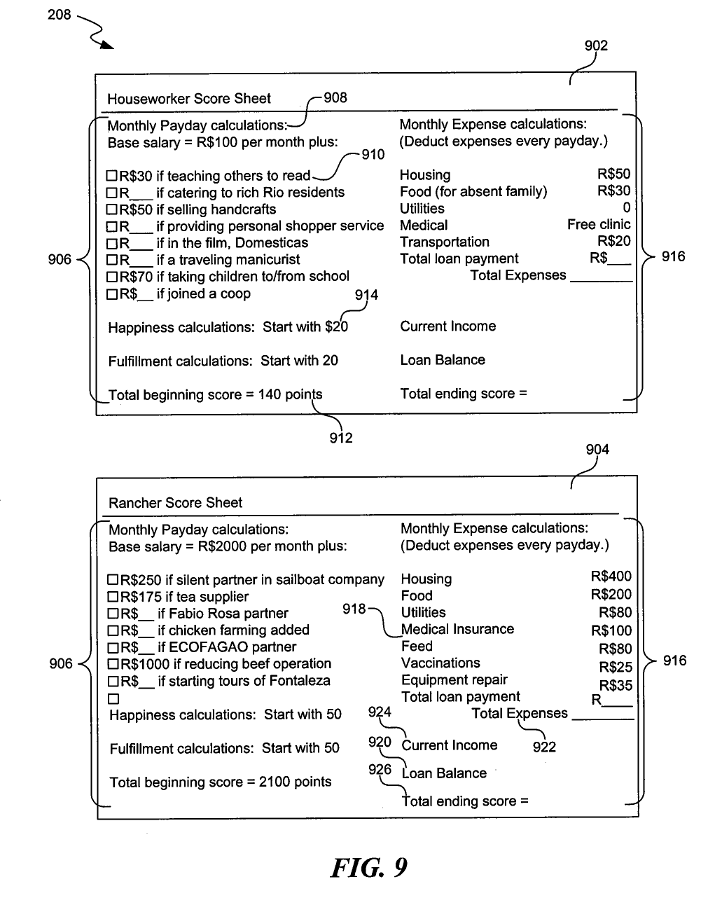

A plurality of scoring sheets 208 can also be included in the game system 100 for keeping score during game play. In some embodiments, the scoring sheets 208 can be used to tally happiness points, fulfillment points, wealth points, etc. In an embodiment shown in FIG. 9, the scoring sheets 208 can be configured to be vocation-specific scoring sheets 208. For example, FIG. 9 illustrates an embodiment of a Brazilian houseworker score sheet 902 and an embodiment of a Brazilian rancher score sheet 904. The scoring sheets 902, 904 can include a first column 906 indicating income information 908, a financial opportunity list 910, starting point amounts 912, point recording spaces 914 for indicating addition and subtraction of happiness and fulfillment points, etc.

The scoring sheets 902, 904 can also have a second column 916 including vocation-specific budget information 918, loan information 920, amounts owed 922, income adjustments 924, total score tally 926, etc. One of ordinary skill in the art will recognize that scoring sheets 208 can include more or less information and keep more or different types of scores. Furthermore, the scoring sheets 208 can be adapted to keep score for any type of vocation, player, denizen, etc. during use of the game system 100. The scoring sheets 208 can be printed, embossed, or otherwise applied to paper, cardboard, plastic, etc. In further embodiments, the scoring sheets 208 can be audibly recorded, digitally recorded, or electronically recorded by other means for storing, receiving, and retrieving first and second column 906, 916 scoring information using a computer and/or other audio-based devices. Moreover, scoring sheets 208 can be configured for single use or, in another embodiment, scoring sheets 208 can be configured for multiple session use.

In accordance with an embodiment of the disclosure, a plurality of players can play a game using the game system 100 with incorporated game components 102, 104, 106, 108, 202 as described above with reference to FIGS. 1-9. In one embodiment, 5 to 8 players can play a game. However, in other embodiments, the number of players can be less then 5 or greater than 8. For example, in some embodiments, the number of players can be 4 or less than 4. In some embodiments, an objective of the game can be to finish with more total points then starting points. Total points can comprise a combination of happiness points, fulfillment points, wealth points, or other type of points. Additionally, total points can take into account banked currency, amounts owed for expenses or loans, etc.

Happiness points, fulfillment points, wealth points, etc. can be attained and lost during the course of a game. The number of points (added or subtracted) can be indicated on player movement spaces 312 or on the playing cards 104. In one embodiment, happiness points can be attained by drawing a playing card 104 that describes such experiences as the marriage of a child, birth of a grandchild, work success, teaching someone how to use a computer, getting a good education for your children, etc. In another embodiment, fulfillment points can be attained by drawing a playing card 104 that describes such experiences as learning to read, taking a computer class, teaching others to read or use technology, your children's success, acquiring a possession you've been saving for, etc. In a further embodiment, wealth points can be calculated from the paper currency (money) attained from such experiences as vocational success (e.g. harvest a good crop, run a successful business, etc.), wise investments, entrepreneurial opportunities, integrating technology into your business, etc.

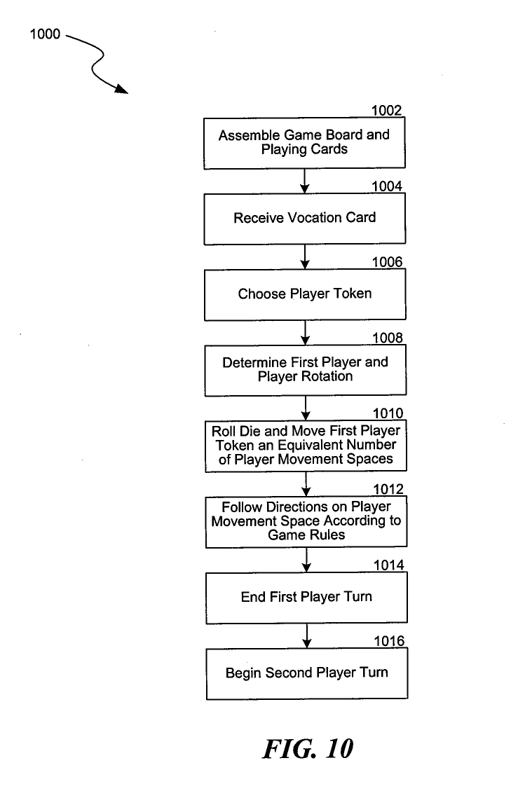

FIG. 10 is a flow diagram of a method 1000 for playing a culture game using the game system 100 in accordance with an embodiment of the disclosure. Before starting the game, and in block 1002, the game board 102 can be assembled, and the playing cards 104 can be shuffled, or otherwise placed in random order, and separated into piles depending on playing card type. In one embodiment, the players can decide upon the amount of play time in advance of beginning play. For example, the players can decide to play for 90 minutes. In other embodiments, the end of the game can be determined by the instructions and/or game rules 110, or by other deciding factors.

In one embodiment, country overview information 412 can be read and/or communicated to all players prior to starting the game. The number of vocation cards 212 used during a game can equal the number of players. In block 1004, each player can receive a vocation card 212 which can determine the role each player will maintain for the duration of the game. In one embodiment, the players can receive vocation cards 212 in a random manner. In another embodiment, the players can choose a vocation card 212. Following vocation assignment, the players can read the vocation information 410 on the received vocation card 212.

Next, in block 1006, each player can choose a player token 106 and place the token 106 on or near the start space 322 (as shown in FIG. 3B). The players can also select one player to act as a banker for the purpose of distributing salaries (paper currency 204), collecting payments during the course of play, assisting with negotiations during the course of play (described in more detail below), etc. The banker, or other designated player, can distribute the vocation-specific scoring sheet 208 to each player based on the assigned vocation as well as each player's specific first month's salary as indicated in the first column 906 of the scoring sheet 208.

To start the game, and in block 1008, a first player and player rotation can be determined. In one embodiment, all players roll the die 108 and the player rolling the highest number can be designated as the first player. The group of players can select to play in clockwise turn or counterclockwise turn. In other embodiments, the player rotation can be determined by the roll of the die 108, the alphabetical order of names, birth date order, age, etc. In block 1010, the first player can roll the die 108 a second time and move the designated player token 106 an equivalent number of player movement spaces 312 from the start space 322. When the first player rests on the final player movement space 312 as indicated by the roll of the die 108, the information on the space 312 can be read and the directions contained within the space 312 can be followed according the game rules 110 (block 1012). After all directions are followed and points are tallied, the first player can end his/her turn in block 1014. In block 1016, a second player can begin his/her turn by rolling the die 108 a second time and moving his/her designated player token 106 the equivalent number of player movement spaces 312, etc.

In accordance with an embodiment of the disclosure, a player can move their designated player tokens 106 on the primary player path 318 on the perimeter 314 of the game board 102. In some embodiments, if a player approaches an intersection between the primary player path 318 and the side path 320, the player can check if the side path 320 is a required path for a player with their assigned vocation. The side paths 320 can be designated with indicators for the vocation to which they apply. If the side path 320 is a required path for their assigned vocation, the player can move their player token 106 onto the player movement spaces 312 of the side path 320.

Side paths 320 can contain player movement spaces 312 that are blank, have instructions to choose an opportunity card 212, have instructions to get paid and/or pay bills, or have other instructions. In one embodiment, if the space 312 is blank, the player can receive a situation card 216. The situation card 216 can be read aloud and directions on the card 216 can be followed.

While on the vocation-specific side path 320, the player may also land on a player movement space 312 that instructs the player to draw an opportunity card 214. The player can read the opportunity information 510 on the card 214 that pertains to their assigned vocation and decide if they want to take advantage of a presented opportunity. Players can decide how they are going to pay for the presented opportunity, if the opportunity is equitable, if the opportunity presents too high of a financial risk, etc. In some embodiments, a roll of the die 108 can determine the outcome of an accepted opportunity. If appropriate, a player can negotiate with other players and/or the banker for a loan in order to pay for a venture opportunity. Negotiations may include agreeing on a loan amount, agreeing on the percentage of the loan, the incremental payment the lender will receive on the player's pay days if the venture succeeds, the amount of the loan that needs to be paid back if the venture fails, etc. In some embodiments, a hand shake can secure an agreement. In other embodiments, contracts can be written to include the agreed terms; while in still other embodiments, a material item can be offered for loan collateral. One of ordinary skill in the art will recognize a variety of negotiations and contracts in accordance with the disclosure.

Such as in real life, different types of loans can be provided to players during the course of game play. For example, micro-financing programs can provide loans to low income earners where the amount of the loan, or the principle, is less than two year's salary. The interest on the micro-financed loan can be negotiable (e.g. between 20-40%, etc.) and can be calculated as simple interest. In this scenario, the interest can be a percent of the loan amount and it is added to the principle amount. The total principle and interest can be paid back over a three-year period, for example. Passbook financing, in another example, can be a loan in any amount and can be available to only middle and upper income earners. It can be calculated at a negotiated interest rate (e.g. 4-18%, etc.) and can be added to the principle and paid over a five-year period, for example.

As players take advantage of opportunities and/or loans during the course of game play, they can mark their earnings and payments accordingly in the second column 916 of the scoring sheet 208. Players can keep track of their incremental payments as well as their total indebtedness. In addition to keeping track of income changes and monies owed, players can also keep track of increases and decreases to their happiness and fulfillment points as they follow directions on the player movement spaces 312 as well as on opportunity and situation cards 214, 216

Players can also stop on player movement spaces 312 designated as a “pay day” space. In one embodiment, pay day spaces are located along the side paths 320. In other embodiments, pay day spaces can be located along the primary player path 318. When players land on a pay day space, the banker can distribute the player's vocation-specific base salary plus any additional income the player has earned through successful venture opportunities. The banker can also deduct the player's monthly expenses as designated on the players scoring sheet 208. The player can also be required to make loan payments when landing on the pay day space.

Once a player has followed the directions provided for the player movement space 312 on which they have landed, marked the appropriate entries on their scoring sheets, made loan payments to other players and/or the banker, etc., their turn can end. Each player can take their turn in order and roll the die 108 to determine the number of player movement spaces 312 to move their player token 106 and follow the indicated directions for the space 312 in which they land.

Life as a denizen of a country can be simulated for a player, such that the player can encounter positive and negative experiences. In one aspect of the disclosure, winning can be achieved by all players and is accomplished by improving combined scores in all categories (e.g. happiness points, fulfillment points, wealth points, etc.). In accordance with some embodiments, competition is downplayed so that each player can assist other players as opportunities are presented. As the end of the game, each player can add up all of the attained points and income, and deduct any loans/debts that are outstanding, to arrive at the final score. In one embodiment, if a player's final score is higher than the players beginning score, the player wins.

Having generally described various embodiments of the disclosure, the same will be readily understood through reference to the following examples, which are provided by way of illustration only and are not intended to be limiting of the present disclosure.

### EXAMPLE 1

The game system 100 as described above with reference to FIGS. 1-10 is described herein in a first example of a game directed to living and working in the country of Brazil. Vocation cards 212 are dispersed and a plurality of players can be one of a street vendor, a teacher, a small farmer, a cattle rancher, a houseworker, etc. A first player, having been assigned the vocation of Street Vendor, rolls the set of die 108 to yield a cumulative number five. The first player can move a first player token 106 five player movement spaces 312 forward from the start space 322 along the primary player path 318. The first player will rest on a final player movement space 312, read the directions printed on the space 312 and follow the directions. In this example, the space says “STOP: Pay annual income tax.” Continuing with the first player's turn, the first player pays the tax according to the information on the space 312 from the currency 204 issued at the beginning of the game. After following the directions on the space 312 to completion, the first player's turn can end.

A second player, having been assigned the vocation of a Teacher, rolls a four on the set of die 108 and moves forward a second player token 106 one player movement space 312 along the primary player path 318 before reaching an intersection with the Farmer and Teacher side path 320d. The second player can then proceed three player movement spaces 312 along the side path 320d before resting on a final player movement space 312. The final player movement space 312 of the second player does not contain directions. In this example, a player that lands on a blank player movement space 312 can draw a situation card 216, such as a “My Life As . . . ” card, from the stack of cards 216 and read the entry designated for the teacher. In this example the situation card 216 says “I have used LTNet's online training to learn how to better use computers in class. Add 10 fulfillment points.” The second player adds 10 fulfillment points to the appropriate space 914 in the first column 906 of the second player's score sheet 208. The second player's turn can end and a third, fourth, etc. player can play a turn before the first player takes a second turn, etc.

### EXAMPLE 2

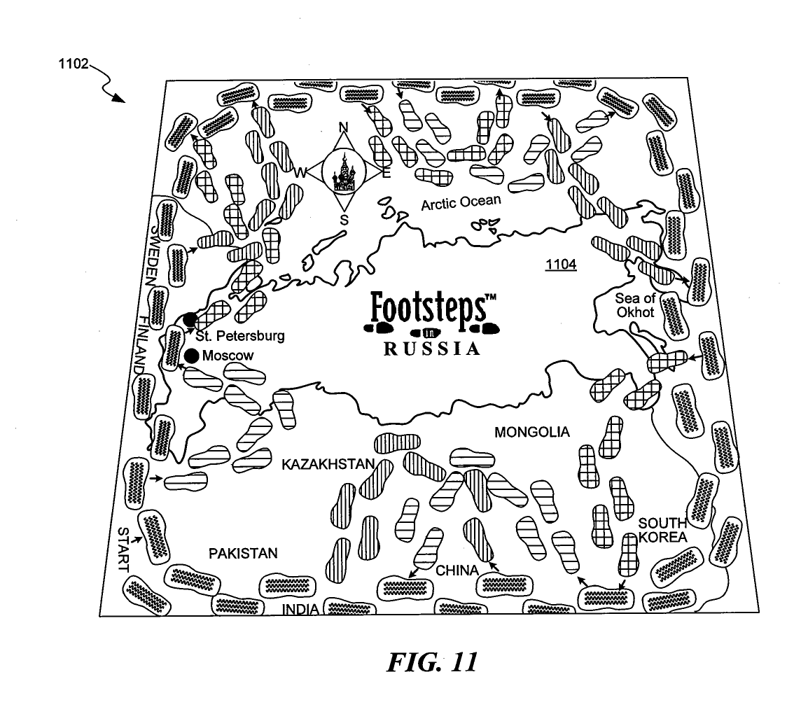

The game system 100 as described above with reference to FIGS. 1-10 is described herein in a second example of game directed to living and working in the country of Russia. FIG. 11 illustrates a game board 1102 having the country of Russia 1104 depicted within the board 1102. Vocation cards 212 are dispersed and a plurality of players can be one of a business owner, a middle manager, a street vendor, a farm laborer, a construction design engineer, etc. First, second, third players, etc. can play in substantially the same format as that described in Example 1.

### EXAMPLE 3

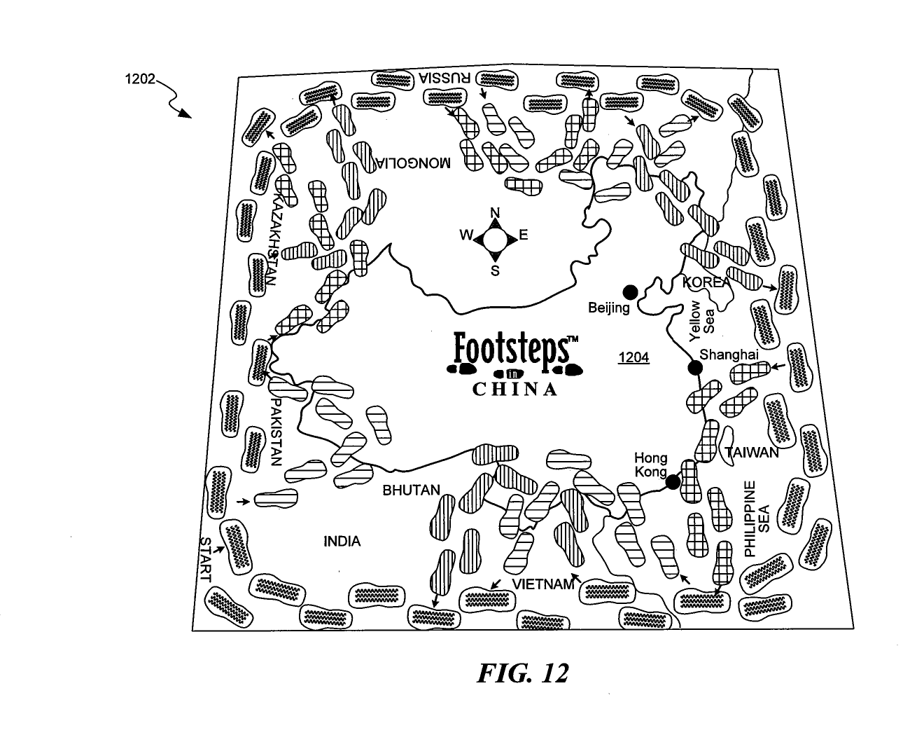

The game system 100 as described above with reference to FIGS. 1-10 is described herein in a third example of game directed to living and working in the country of China. FIG. 12 illustrates a game board 1202 having the country of China 1204 depicted within the board 1202. Vocation cards 212 are dispersed and a plurality of players can be one of a farmer, a business owner, a communist teacher, a migrant construction worker, an IT professional, etc. First, second, third players, etc. can play in substantially the same format as that described in Example 1.

### EXAMPLE 4

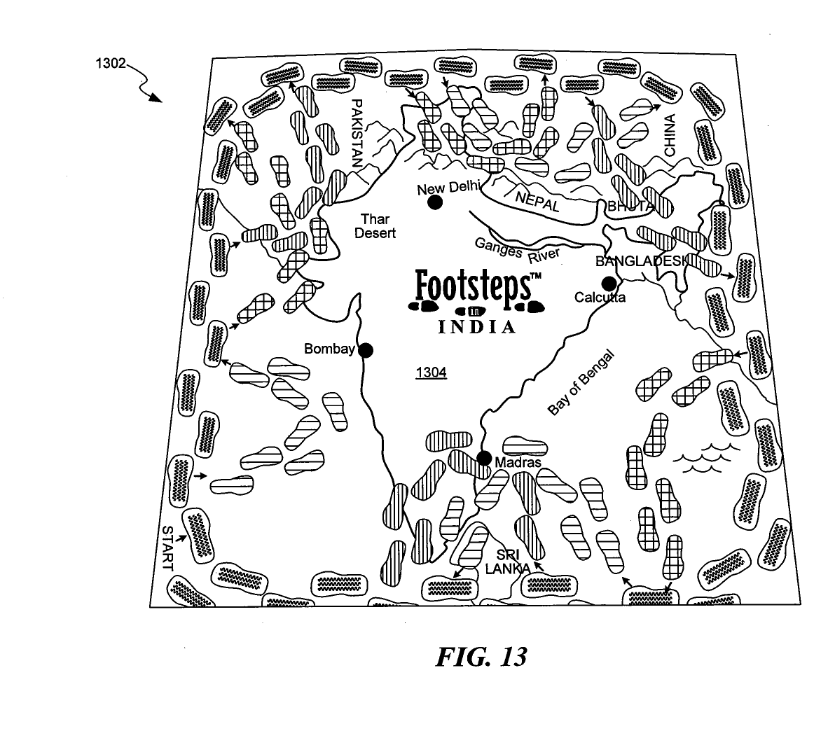

The game system 100 as described above with reference to FIGS. 1-10 is described herein in a fourth example of game directed to living and working in the country of India. FIG. 13 illustrates a game board 1302 having the country of India 1304 depicted within the board 1302. Vocation cards 212 are dispersed and a plurality of players can be one of a small farmer, an administrator, an industrial worker, a houseworker, a street vendor, etc. First, second, third players, etc. can play in substantially the same format as that described in Example 1.

In one embodiment, the game system 100 can incorporate situations that simulate real life in the representative country. For example, situations and life opportunities presented during play can be born of real documented news sources and real-life in-country experiences. The content, situations, events and experiences played in the game system 100 can be based on actual relevant in-country experiences. The game system 100 can include experiences and current events from recent years (e.g. the last five years, etc.). The use of the game system 100 facilitates the supply of additional playing cards 104, including vocation cards 212, opportunity cards 214, situation cards 216, etc., to update current events and experiences indicative of work and life in the representative country. Additionally, directions and situations printed on the game board 102 within the player movement spaces 312 can also be updated with player movement space replacements, overlaying stickers, etc. Further, the game system 100 can be adapted for large group play (e.g., greater than 8 players) by addition of playing cards, scoring sheets 208, country-specific paper currency 204, identifiable player tokens 108, etc., for example, in a game expansion set. Replacement or addition of game components, such as playing cards 104, player movement spaces 312, scoring sheets 208, country-specific paper currency 204 and/or other value-containing components, etc., can be provided for purchase as a physical update set or kit and/or as a game expansion set, provided for purchase on a CD for use on a computer, downloaded from a supplier site on the internet, etc.

In another embodiment of the disclosure, the game system 100 can also include a discussion guide (not shown) for use before, during, and/or after game play. The discussion guide can facilitate discussion among the players with regard to the situations experienced and life lessons learned during the course of a game session. In one embodiment, the discussion guide can include a plurality of discussion questions. In another embodiment, the discussion guide can include additional general and specific information about the representative country and the life of its denizens. One of ordinary skill in the art will recognize these and other features to include in a discussion and/or learning guide to be used in conjunction with the game system 100 for learning about life and business in emerging markets and countries. In some embodiments, the game system 100 and discussion guide can be used for training sessions for a plurality of groups, such as, but not limited to, employees of international and domestic businesses, students (e.g. elementary through graduate school), civic duty and volunteer groups, travelers, etc.

The varied conditions, opportunities, and challenges of living and working in different countries and cultures, particularly in less developed countries, are poorly understood by individuals, organizations, and businesses not immersed or presently residing in the respective geographical locations. For example, when playing conventional travel and trivia games, participants do not assume realistic lifestyle changes, adapt to alternate cultures, or play character roles. Instead, participants select their playing preferences, make decisions, and experience life as they would see fit within the constraints of their preferred or understood culture.

In contrast, the game system 100 of the present disclosure can feature emerging market countries; and be designed to give players a global awareness by understanding life in the particular country associated with the game that they are playing. For example, players can assume roles at three levels of income: poverty, middle-income, and the wealthy. Players can experience events common to residents of the country in general, as well as events specific to their income level and vocation. Further, the game system 100 can provide educational opportunities and entertainment for one or more participants.

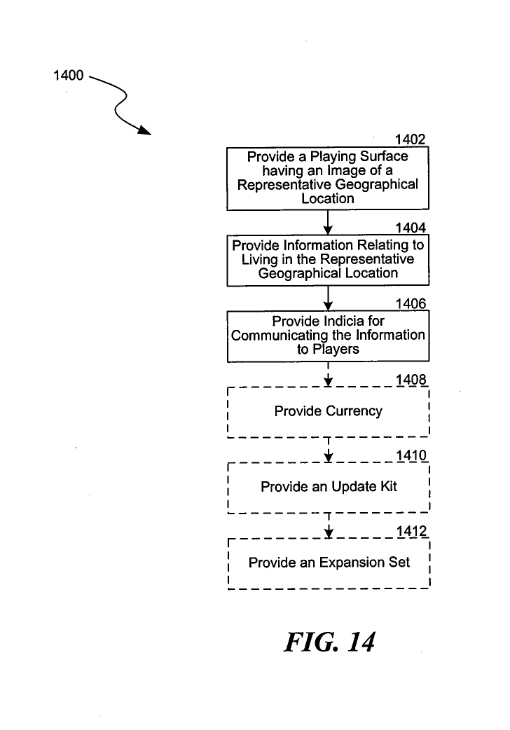

Another aspect of the disclosure is directed toward a method for developing and implementing a game. FIG. 14 is a flow diagram illustrating a method 1400 for developing and implementing a game that simulates living in a representative geographical location. In one embodiment, the geographical location can be a representative country, such as a country having an emerging market. The method 1400 can include providing a playing surface (block 1402). The playing surface can include an image of the representative geographical location and a player movement path. The player movement path can include a plurality of spaced-apart player position spaces. In some embodiments, the player movement path can permit movement of one or more player tokens during game play. In one embodiment, the player movement path can be a primary movement path, and the playing surface can further include a plurality of side paths having additional player movement spaces.

The method can also include providing information relating to living in the representative geographical location (block 1404). In one embodiment, the information includes descriptions of possible vocations available to denizens of the representative geographical location (e.g., houseworker, rancher, teacher, etc.). In other embodiments, the information can include possible opportunities available to the denizens (e.g., investment opportunities, teaching opportunities, new business opportunities, etc.), possible life situations encountered by the denizens (e.g., learning events, family events, meeting new people, travel, etc.), and/or one or more current events relevant to the denizens (e.g., political vote results; earthquake; international trade laws change; etc.).

The method 1400 can further include providing indicia for communicating the information to players (block 1406). For example, the information can be presented on playing cards, such as vocation cards, opportunity cards, situation cards, player movement spaces, etc. Optionally, the method 1400 can further include providing currency for simulating disbursement of an income and/or collection of a payment for living expenses from a player during game play (block 1408).

Optionally, the method 1400 can include providing an update kit (block 1410). The update kit can include replacement indicia having updated information relating to living in the representative geographical location. For example, information relating to income levels, job opportunities, current events, etc. can be acquired periodically, and the newly acquired information can be provided on update indicia and included in the update kit. The method 1400 can also optionally include providing an expansion set for permitting a greater number of players to play the culture game (block 1412). In one embodiment, the expansion set can include additional indicia having the information, additional player tokens, additional currency, etc.

As illustrated in FIGS. 1-14, the game system 100 can be a physical game played on a playing surface. In another embodiment, the game system 100 can be contained within a computer software program. The game system 100, as practiced in a distributed computing environment, can facilitate multiple players in a single game, a single player playing with other computer-generated players, multiple players playing remotely over the internet, etc.

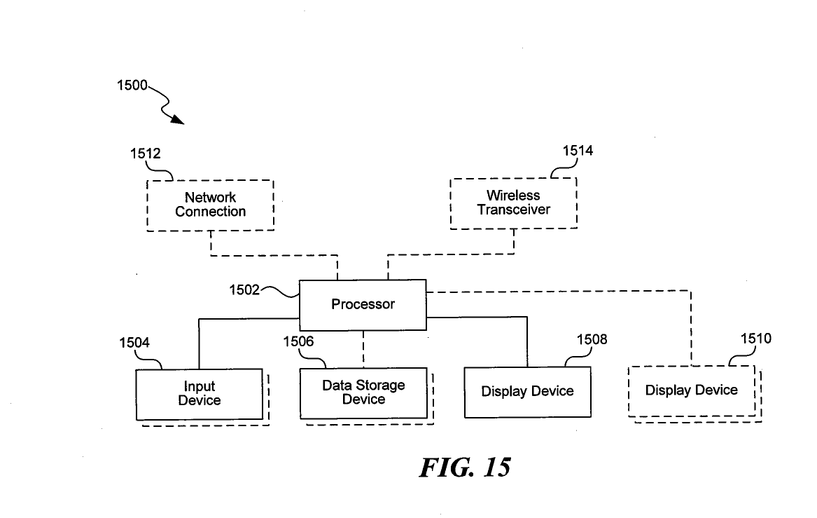

FIG. 15 and the following discussion provide a brief, general description of a suitable computing environment in which aspects of the disclosure can be implemented. Although not required, aspects and embodiments of the disclosure will be described in the general context of computer-executable instructions, such as routines executed by a general-purpose computer, e.g., a server or personal computer. Those skilled in the relevant art will appreciate that the game system 100 can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers, networked game consoles, and the like. The game system 100 can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

The disclosure can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the game system 100 described above may be stored or distributed on computer-readable media, including magnetic and optically readable and removable computer discs, stored as firmware in chips (e.g., EEPROM chips), as well as distributed electronically over the Internet or over other networks (including wireless networks). Furthermore, versions of the images illustrated in FIGS. 1-9 and 11-13, and as described above, can be display pages viewed on a display screen. Those skilled in the relevant art will recognize that portions of the invention may reside on a server computer, while corresponding portions reside on a client computer. Data structures and transmission of data particular to aspects of the disclosure are also encompassed within the scope of the disclosure.

Referring to FIG. 15, one embodiment of the disclosure employs a computer 1500, such as a personal computer or workstation, having one or more processors 1502 coupled to one or more user input devices 1504 and data storage devices 1506. The computer is also coupled to at least one output device such as a display device 1508 and one or more optional additional output devices 1510 (e.g., printer, plotter, speakers, tactile or olfactory output devices, etc.). The computer may be coupled to external computers, such as via an optional network connection 1512, a wireless transceiver 1514, or both.

The input devices 1504 may include a keyboard and/or a pointing device such as a mouse. Other input devices are possible such as a microphone, joystick, pen, game pad, scanner, digital camera, video camera, and the like. The data storage devices 1506 may include any type of computer-readable media that can store data accessible by the computer 1500, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not shown in FIG. 15).

From the foregoing, it will be appreciated that specific embodiments of the disclosure have been described herein for purposes of illustration, but that various modifications may be made without deviating from the spirit and scope of the disclosure. Accordingly, the disclosure is not limited except as by the appended claims.

I/We claim:

1. A game system, comprising:
a playing surface having an image for representing a geographical location;
a plurality of spaced-apart player movement spaces for positioning one or more player tokens on the playing surface, the player movement spaces arranged in one or more paths on the playing surface;
a plurality of vocation indicia for communicating vocation based information, the vocation based information including a vocation and a vocation description assumable by a player; and
a plurality of instructional play indicia for communicating one or more play events, wherein the one or more play events include a description of a possible life experience that a denizen of the geographical location may experience.

2. The game system of claim 1 wherein the vocation based information further includes an income level associated with the vocation.

3. The game system of claim 1 wherein the vocation based information further includes a description of one or more possible work-related challenges associated with the vocation.

4. The game system of claim 1 wherein the vocation based information further includes a description a background education level associated with a vocation.

5. The game system of claim 1 wherein the vocation description describes a possible vocation of a denizen of the representative geographical location;

6. The game system of claim 1 wherein the one or more paths include a primary player path and one or more side paths, the side paths provided for directional movement of the player token away from the primary player path, and wherein the side paths are vocation-specific side paths

7. The game system of claim 1 wherein the spaced-apart player movement spaces include player instructions, and wherein the instructions communicate a player action.

8. The game system of claim 1 wherein the image for representing a geographical location includes an image of a map of the geographical location.

9. The game system of claim 1 wherein the image for representing the geographical location includes an image of a map of a representative country, and wherein the vocation based information includes the vocation description indicative of a country-specific vocation.

10. The game system of claim 9, further comprising country-specific paper currency, the currency having one or more denominations.

11. The game system of claim 9 wherein the vocation based information includes one or more words communicated in a first language used in the representative country, and wherein the game system further comprises a translation guide for translating the one or more words into a second language.

12. The game system of claim 1, further comprising a plurality of vocation-specific scoring sheets, the scoring sheets including income related information and living expense related information.

13. The game system of claim 1 wherein the vocation indicia includes general culture information describing denizen life in the geographical location.

14. The game system of claim 1 wherein the plurality of instructional play indicia includes opportunity indicia for communicating one or more opportunities presentable to a player.

15. The game system of claim 1 wherein communication of the one or more play events include:
Information about a current event associated with the representative geographical location; and
instructions for responding to the current event during game play.

16. The game system of claim 1 wherein the plurality of instructional play indicia includes one or more point totals associated with the indicia.

17. The game system of claim 1 wherein:
the plurality of vocation indicia includes a plurality of vocation cards, the vocation cards having the vocation based information disposed thereon; and
the plurality of instructional play indicia includes a plurality of instructional play cards, the instruction play cards having the description of the possible life experience disposed thereon.

18. The game system of claim 1 wherein the game system comprises a physical game board having the playing surface.

19. The game system of claim 1 wherein the game system comprises one or more software programs for permitting play of a game in a computing environment, and wherein the playing surface is displayed as a virtual game board on a display device.

20. A game system for playing games that simulate living in a representative country, the game system comprising:
a game board having a playing surface, the playing surface including:
an image of the representative country;
a player movement path having spaced-apart player position spaces, the player position spaces providing designated spaces on the playing surface in which player tokens may stop during play, and wherein one or more player position spaces include player instructions for taking an action; and
a plurality of vocation cards for communicating vocation based information, the vocation based information including a vocation and a vocation description assumable by a player, wherein the vocation description describes a possible vocation of a denizen of the representative country.

21. The game system of claim 20, further comprising a plurality of opportunity cards for communicating one or more opportunities to a player, wherein the opportunities include one or more possible opportunities available to the denizen of the representative country.

22. The game system of claim 20, further comprising a plurality of situation cards for communicating one or more life experiences to a player, wherein the life experiences include one or more possible life situations experienced by the denizen of the representative country.

23. The game system of claim 20, further comprising:
a plurality of opportunity cards for communicating one or more opportunities to a player, wherein the opportunities include one or more possible opportunities available to the denizen of the representative country;
a plurality of situation cards for communicating one or more life experiences to a player, wherein the life experiences include one or more possible life situations experienced by the denizen of the representative country;
country-specific currency, the currency having one or more denominations, wherein each player receives currency based on an income-level; and
a plurality of player tokens for associating with a player.

24. The game system of claim 20 wherein the plurality of vocation cards communicates vocation based information through textual description.

25. The game system of claim 20 wherein the opportunity cards communicate one or more vocation-dependent opportunities.

26. The game system of claim 20 wherein the plurality of opportunity cards includes one or more opportunity cards communicating an investment opportunity, the investment opportunity having an associated risk value.

27. The game system of claim 20, further comprising a random number generating device for randomly generating a number, wherein the number permits movement of the player token on the player movement path by an equal number of player position spaces.

28. The game system of claim 20, wherein the representative country includes at least one of Brazil, Russia, China and India.

29. A method for developing and implementing a game that simulates living in a representative geographical location, the method comprising:
providing a playing surface, the playing surface including an image of the representative geographical location and a player movement path, the player movement path having a plurality of spaced-apart player position spaces;
providing information relating to living in the representative geographical location, wherein the information includes descriptions of possible vocations available to denizens of the representative geographical location; and
providing indicia for communicating the information to players.

30. The method of claim 29 wherein providing information includes providing descriptions of possible opportunities available to the denizens, possible life situations encountered by the denizens, and one or more current events relevant to the denizens.

31. The method of claim 29, further comprising providing currency for simulating disbursement of an income and collection of a payment for living expenses from a player during game play.

32. The method of claim 29 wherein providing indicia for communicating the information to players includes providing playing cards having textual information.

33. The method of claim 29, further comprising providing an update kit, the update kit including replacement indicia having updated information relating to living in the representative geographical location.

34. The method of claim 29, further comprising providing an expansion set for permitting a greater number of players to play the culture game, the expansion set including additional indicia having the information.
